(19) United States
(12) Patent Application Publication
(10) Pub. No.: US 2023/0087486 A1
(43) Pub. Date: Mar. 23, 2023

(54) METHOD AND APPARATUS FOR PROCESSING AN INITIAL AUDIO SIGNAL

(71) Applicant: Fraunhofer-Gesellschaft zur Förderung der angewandten Forschung e.V., München (DE)

(72) Inventors: Jan RENNIES-HOCHMUTH, Oldenburg (DE); Johanna BAUMGARTNER-KRONE, Oldenburg (DE)

(21) Appl. No.: 18/058,753

(22) Filed: Nov. 24, 2022

Related U.S. Application Data
(63) Continuation of application No. PCT/EP2020/065035, filed on May 29, 2020.

(51) Int. Cl. G10L 21/02; G10L 25/60

(52) U.S. Cl. CPC G10L 21/02; G10L 25/60

(57) ABSTRACT

A method processes an initial audio signal, having a target portion and a side portion, by receiving of the initial audio signal; modifying the received initial audio signal using a first signal modifier to obtain a first modified audio signal and modifying the received initial audio signal using a second signal modifier to obtain a second modified audio signal; comparing received initial audio signal with the first modified audio signal to obtain a first perceptual similarity value describing the perceptual similarity between the initial audio signal and the first modified audio signal; and comparing the received initial audio signal with the second modified audio signal to obtain a second perceptual similarity value describing the perceptual similarity between the initial audio signal and the second modified audio signal; and selecting the first or second modified audio signal dependent on the respective first or second perceptual similarity value.

### CROSS-REFERENCE TO RELATED APPLICATION

This application is a continuation of copending International Application No. PCT/EP2020/065035, filed May 29, 2020, which is incorporated herein by reference in its entirety.

### TECHNICAL FIELD

Embodiments of the present invention refer to a method for processing an initial audio signal (like recordings or raw data) and to a corresponding apparatus. Embodiments refer to an approach with (method and algorithm) for improving speech intelligibility and for listening to broadcast audio material.

### BACKGROUND OF THE INVENTION

When producing and broadcasting audio media and audiovisual media (e.g. film, TV, radio, podcasts, YouTube videos), sufficiently high speech intelligibility in the final sound mixing is not always ensured, e.g. due to excessive added background sounds (music, sound effects, noise in the recordings, etc.).

This is in particular problematic for people with hearing impairment, but improving speech intelligibility would also be advantageous for people with normal hearing or non-native speaking listeners.

A basic problem when producing audio media and audiovisual media is that background signals (music, sound effects, atmosphere) make up a significant sound-aesthetic part of the production, i.e. the same cannot be considered as “interfering noise” which should be eliminated as far as possible. Therefore, all methods aimed at improving speech intelligibility or reducing the listening effort for this application should additionally consider that the originally intended sound character is only changed as little as possible to account for the high quality requirements and creative aspects of sound production. However, at present, no technical method or tool exists for ensuring an optimum tradeoff between good intelligibility and maintaining the sound scenes/recordings.

However, there are different technical approaches, which can basically produce an improvement of speech intelligibility (or reduction of listening effort) in audio media and audiovisual media:

One solution could be for the professional sound engineers to manually produce an alternative audio mix so that end users could choose freely between the original mix and the mix with improved speech intelligibility. The mix with improved intelligibility could be produced, e.g., by employing hearing loss simulations and making sure that the intended mix is suitable also for listeners with a target hearing loss [1]. However, such a manual process would be very cost-intensive and not applicable to a large part of the produced audio/audiovisual media.

As alternative solutions to provide an automatic signal enhancement, there are different methods for reducing or eliminating undesired signal portions (e.g. interfering noises) which, however, differ from the technical approach of the present invention:

Speech intelligibility improvement by interfering noise reduction methods for mixed signals: Such methods aim to process a mixed signal including both the target signal (e.g. speech) as well as interfering signals (e.g. background noise) such that as large a portion of the interfering noise as possible is eliminated while the target signal ideally remains as it is (e.g. method according to [2]). Since these methods have to estimate the respective portions of target and interfering noise components in the mixed signal, the same are always based on assumptions on the physical characteristics of the signal components. Such algorithms are used, for example, in hearing aids and mobile phones, are known technology and are continuously developed further.

In the last years, increasingly, methods based on machine learning (neuronal networks) were presented that aim to separate different sources in a mixed signal. Based on large amounts of data, these methods are trained for specific problems (e.g. separating several speakers in a mix [3]) and can basically be used to extract the dialogue from the atmosphere/music in audiovisual media, and therefore provide the basis for a remix with improved SNR. In [4], such an approach has been presented for giving the user the option of adjusting the ratio of speech to background himself.

Speech intelligibility improvement by pre-processing speech signals: In some applications, the target signal (e.g. speech) is separate from other signal portions; therefore, the same is not a mixed signal as described above and the method does not need any estimation of which signal components correspond to the target and interfering noise. This is, for example, the case for train station announcements. At the same time, on a signal processing level, the interfering noise cannot be influenced, i.e. eliminating or reducing the interfering noise (e.g. the noise of a passing train interfering with the intelligibility of the station announcement) is not possible. For such application scenarios, methods exist that preprocess the target signal adaptively such that intelligibility of the same is optimum or improved in the currently present interfering noise (e.g. method of [5]). Such methods use, for example, bandpass filtering, frequency-dependent amplification, time delay and/or dynamic compression of the target signal and would basically also be applicable for audiovisual media when the background noise/atmosphere is not to be (significantly) amended.

Encoding target and background noise as separate audio objects: Further, methods exist that, when encoding and transmitting audio signals, parametrically encode information on the target signal, such that the energy of the same can be separately adjusted during decoding at the receiver. Increasing the energy of the target object (e.g. speech) relative to the other audio objects (e.g. atmosphere) can result in improved speech intelligibility [11].

Detection and level adaptation of speech signals in a mixed signal: Above that, technical systems exist, which identify speech passages in a mixed signal and modify these passages with the aim of obtaining improved speech intelligibility, e.g. raising their volume. Depending on the type of modification, this improves speech intelligibility only when no further interfering noises exist in the mixed signal at the same time [12].

Lowering channels that do not primarily include speech: In multichannel audio signals that are mixed in such a way that one channel (typically the center) includes a large part of the speech information and the other channels (e.g. left/right) mainly include background noise, one technical solution consists in attenuating the non-speech channels by a fixed gain (e.g. by 6 dB) and in that way to improve the signal to noise ratio (e.g. sound retrieval system (SRS) dialog clarity or adapted downmix rules for surround decoder).

In such methods, it can happen that background noise portions that are already very low and actually have no detrimental effect on speech intelligibility are also attenuated. This might reduce the overall sound-aesthetic impression since the atmosphere intended by the sound engineer can no longer be perceived. For preventing this, U.S. Pat. No. 8,577,676 B2 describes a method where the non-speech channels are only lowered to that effect that a metric for speech intelligibility reaches a specific threshold, but not more. Further, U.S. Pat. No. 8,577,676 B2 discloses a method where a plurality of frequency-dependent attenuations is calculated, each having the effect that a metric for speech intelligibility reaches a specific threshold. Then, the option that maximizes the loudness of the background noise is selected from the plurality of options. This is based on the assumption that this maintains the original sound character as best as possible.

Based thereon, US 2016/0071527 A1 describes a method where the non-speech channels are not lowered or not lowered so much when the same, in contrary to the general assumption, also include relevant speech information and therefore lowering might be detrimental for intelligibility. This document also includes a method where a plurality of frequency-dependent attenuations is calculated and the one that maximizes the loudness of the background noise is selected (again based on the assumption that this maintains the original sound character as best as possible).

Both US patent documents describe very specific methods in their independent claims (e.g. scaling the lowering factor with a probability for the occurrence of speech) that are not required for the invention described herein. Therefore, this invention can be realized without using the technology disclosed in U.S. Pat. No. 8,577,676 B2 and US 2016/0071527 A1.

U.S. Pat. No. 8,195,454 B2 describes a method detecting the portions in audio signals where speech occurs by using voice activity detection (VAD). Then, one or several parameters are amended (e.g. dynamic range control, dynamic equalization, spectral sharpening, frequency transposition, speech extraction, noise reduction, or other speech enhancing action) for these portions, such that a metric for speech intelligibility (e.g. the speech intelligibility index (SII) [6]) is either maximized or raised above a desired threshold. Here, hearing loss or also the preference of the listener or the noise in the listening environment can be considered.

U.S. Pat. No. 8,271,276 B1 describes loudness or level adaptation of speech segments with an amplification factor that depends on preceding time segments. This is not relevant for the core of the invention described herein and would only become relevant when the invention described herein simply changed the loudness or the level of the segments identified as speech in dependence on preceding segments. Adaptations of the audio signals beyond amplifying the speech segments such as source separation, lowering the background noise, spectral variation, dynamic compression, are not included. Therefore, the steps disclosed in U.S. Pat. No. 8,271,276 B1 are also not detrimental.

An objective of the present invention is to provide a concept enabling an improved trade-off between (speech) intelligibility and maintaining the sound scenes.

### SUMMARY

According to an embodiment, a method for processing an initial audio signal having a target portion and a side portion, may have the following steps:
a. receiving of the initial audio signal;
b. modifying the received initial audio signal by use of a first signal modifier to obtain a first modified audio signal;
   modifying the received initial audio signal by use of a second signal modifier to obtain a second modified audio signal;
c. evaluating the first modified audio signal with respect to an evaluation criterion to obtain a first evaluation values describing a degree of fulfilment of the evaluation criterions;
   evaluating the second modified audio signal with respect to the evaluation criterion to obtain a second evaluation values describing a degree of fulfilment of the evaluation criterions; and
d. selecting the first or second modified audio signal dependent on the respective first or second evaluation value; wherein the step of selecting is performed based on a plurality of independent first evaluation values and independent second evaluation values or based on at least two independent evaluation criterions.

Another embodiment may have a non-transitory digital storage medium having stored thereon a computer program for performing a method for processing an initial audio signal having a target portion and a side portion, having the steps of:
a. receiving of the initial audio signal;
b. modifying the received initial audio signal by use of a first signal modifier to obtain a first modified audio signal;
   modifying the received initial audio signal by use of a second signal modifier to obtain a second modified audio signal;
c. evaluating the first modified audio signal with respect to an evaluation criterion to obtain a first evaluation values describing a degree of fulfilment of the evaluation criterions;
   evaluating the second modified audio signal with respect to the evaluation criterion to obtain a second evaluation values describing a degree of fulfilment of the evaluation criterions; and
d. electing the first or second modified audio signal dependent on the respective first or second evaluation value; wherein the step of selecting is performed based on a plurality of independent first evaluation values and independent second evaluation values or based on at least two independent evaluation criterions,
   when said computer program is run by a computer.

According to another embodiment, an apparatus for processing an initial audio signal having a target portion and a side portion may have: an interface for receiving the initial audio signal; a first signal modifier for modifying the received initial audio signal to obtain a first modified audio signal and a second signal modifier for modifying the received initial audio signal to obtain a second modifier audio signal; an evaluator for evaluating the first modified audio signal with respect to an evaluation criterion to obtain a first evaluation value describing a degree of fulfilment of the evaluation criterion and evaluating the second modified audio signal with respect to the evaluation criterion to obtain a second evaluation value describing a degree of fulfilment of the evaluation criterion; and a selector for selecting the first or second modified audio signal dependent on the respective first or second perceptual evaluation similarity value; wherein the step of selecting is performed based on a plurality of independent first and second evaluation values or based on at least two independent evaluation criterions.

An embodiment of the present invention provides a method for processing an initial audio signal comprising a target portion (e.g., speech portion) and a side portion (e.g., ambient noise). The method comprises the following four steps:
1. receiving of the initial audio signal;
2. modifying the received initial audio signal by use of a first signal modifier to obtain a first modified audio signal and modifying the received initial audio signal by use of a second signal modifier to obtain a second modified audio signal second;
3. evaluating the first modified audio signal with respect to an evaluation criterion to obtain a first evaluation value describing a degree of fulfilment of the evaluation criterion and evaluating the second modified audio signal with respect to the evaluation criterion to obtain a second evaluation value describing a degree of fulfilment of the evaluation criterion;
4. selecting the first or second modified audio signal dependent on the respective first or second evaluation value.

According to embodiments the evaluation criterion can be one or more out of the group comprising perceptual similarity, speech intelligibility, loudness, sound pattern and spatiality. Note the step of selecting may according to embodiments be performed based on a plurality of independent first and second evaluation values describing independent evaluation criterions. The evaluation criterion and especially the step of selecting may depend on a so-called optimization target. Thus, the method comprises according to embodiments the step of receiving an information on an optimization target defining individual preference; wherein the evaluation criterion is dependent on the optimization target; or wherein the steps modifying and/or evaluating and/or selecting are dependent on the optimization target; or wherein a weighting of independent first and second evaluation values describing independent evaluation criterions for the step of selecting is dependent on the optimization target.

For example, if the optimization target is a combination of two elements, e.g. optimal speech intelligibility and tolerable perceptual similarity between the initial audio signal and the modified audio signal, a weighting for the selection may be performed. For example, these two criteria, speech intelligibility and perceptual similarity may be evaluated separately, such that respective evaluation values for the evaluation criteria are determined, wherein then the selection is performed based on weighted evaluation values. The weighting is dependent on the optimization target, which vice versa can be set by individual preferences.

According to embodiments, the steps of adapting, of evaluating and of selecting may be performed by the use of neuro-neural networks/artificial intelligence.

According to an embodiment, it is assumed that the speech intelligibility is improved in a sufficient manner by the two or more used modifiers. Expressed from another point of view this means that just the modifiers, which enable a sufficiently high improvement of the speech intelligibility or output a signal where the intelligibility of speech is sufficient are taken into account. In a next step a selection between the differently modified signals is made. For this selection the perceptual similarity is used as an evaluation criterion so that the steps 3 and 4 (cf. above method) can be performed as follows:
3. comparing received initial audio signal with the first modified audio signal to obtain a first perceptual similarity value describing the perceptual similarity between the initial audio signal and the first modified audio signal; and comparing the received initial audio signal with the second modified audio signal to obtain a second perceptual similarity value describing the perceptual similarity between the initial audio signal and the second modified audio signal; and
4. selecting the first or second modified audio signal dependent on the respective first or second perceptual similarity value.

According to an embodiment of the present invention the first modified audio signal is selected, when the first perceptual similarity value is higher than the second perceptual similarity value (the high first perceptual similarity value indicating a higher perceptual similarity of the first modified audio signal); vice versa, the second modified audio signal is selected when the second perceptual similarity value is higher than the first perceptual similarity value (the high second perceptual similarity value indicating a higher perceptual similarity of the second modified audio signal). According to further embodiments, instead of a perceptual similarity value another value, like the loudness value, may be used.

This adapted method having the step 3 of comparing and the step 4 of selecting based on perceptual similarity values can be enhanced according to further embodiments by additional steps after the step 2 and before the step 3 of evaluating the first and second modified signal with respect to another optimization criterion, e.g. with respect to the voice intelligibility. As described above, it is possible in this case that some modified signals are not taken into account, since this first evaluation criterion is not fulfilled (sufficiently), e.g. when the speech intelligibility is too low. Alternatively, it is possible that all evaluation criteria can be taken into account during the step of selecting unweighted or weighted. This weighting can be selected by the user.

According to embodiments, the method further comprising the step of outputting the first or second modified audio signal dependent on the selection.

An embodiment of the present invention provides a method, wherein the target portion is the speech portion of the initial audio signal and the side portion is the ambient noise portion of the audio signal.

Embodiments of the present invention are based on defining that different speech intelligibility options vary with regard to their improvement effectiveness, dependent on a plurality of factors of influence, e.g., dependent on the input audio stream or input audio scene. The optimal speech intelligibility algorithm can also vary from scene to scene within one audio stream. Therefore, embodiments of the present invention analyze the different modifications of the audio signal, especially with regard to the perceptual similarity between the initial audio signal and the modified audio signal so as to select the modifier/modified audio signal having the highest perceptual similarity. For the first time, this system/concept enables that the overall sound is perceptually changed only as much as necessary, but as little as possible in order to fulfil both requirements, i.e., to improve speech intelligibility (or reduce listening effort) of the initial signal while at the same time to influence the sound aesthetic components as little as possible. This represents a significant reduction of efforts and costs compared to non-automatic methods and a significant added value with respect to the methods that so far are used to improve intelligibility as only boundary condition. Since maintaining this sound aesthetic represents a significant component of the user's acceptance that has so far not been considered in automated methods.

According to an embodiment, the step of outputting the initial audio signal is performed instead of outputting the first or second modified audio signal, when the respective first or second perceptual similarity value fall below a threshold. “below” indicates that the modified signal(s) are not sufficiently similar to the initial audio signal. This is advantageous since the system enables both automatic examination of sound mix for speech intelligibility or listening efforts and at the same time it ensures the overall sound is perceptually changed in an effective manner.

An embodiment of the present invention provides a method, wherein the step of comparing comprises extracting the first and/or second perceptual similarity value by use of a (perception) model, like a PEAQ model, a POLQA model, and/or a PEMO-Q model [8], [9], [10]. Note PEAQ, POLQA and PEMOQ are specific models trained to output perceptual similarity of two audio signals. According to embodiments, the degree of processing is controlled by a further model.

Note that according to an embodiment the first and/or second perceptual similarity value is dependent on a physical parameter of the first or second modified audio signal, a volume level of the first or second modified audio signal, a psychoacoustic parameter for the first or second modified audio signal, a loudness information of the first or second modified audio signal, a pitch information of the first or second modified audio signal, and/or a perceived source width information of the first or second modified audio signal.

An embodiment of the present invention provides a method, wherein the first and/or second signal modifier is configured to perform an SNR increase (e.g. for the initial audio signal), a dynamic compression (e.g. of the initial audio signal); and/or wherein the step of modifying comprises increasing a target portion, increasing a frequency weighting for the target portion, dynamically compressing the target portion decreasing the side portion, decreasing a frequency weighting for the target portion, if the initial audio signal comprises a separate target portion and a separate side portion; alternatively modifying comprises performing a separation of the target portion and the side portion, if the initial audio signal comprises a combined target portion and side portion. In general this means that an embodiment of the present invention provides a method, wherein the first and/or second modified audio signal comprises the target portion moved into the foreground and the side portion moved into the background and/or a speech portion as the target portion moved into the foreground and an ambient noise portion as the side portion moved into the background.

According to embodiments the step of selecting is performed taking into consideration one or more further factors like grade of hardness of hearing for hearing-impaired persons, individual hearing performance; individual frequency-dependent hearing performance; individual preference; and/or individual preference regarding signal modification rate.

Similarly, according to embodiments, the step of modifying and/or comparing is performed taking into consideration one or more factors, like grade of hardness of hearing for hearing impaired persons, individual hearing performance; individual frequency dependent hearing performance; individual preference; and/or individual preference regarding signal modification rate. Thus, selecting, modifying and/or comparing can also consider individual hearing or individual preferences.

According to embodiments, the model for controlling the processing can be configured, e.g., with regard to hearing loss or individual preferences.

According to an embodiment the step of comparing is performed for the entire initial audio signal and the entire first and second modified audio signal or for the target portion of the individual audio signal compared with a respective target portion of the first and second modified audio signal or for the side portion of the initial audio signal compared with a side portion of the first and second modified audio portion.

An embodiment of the present invention provides a method, wherein the method further comprises the initial steps of analyzing the initial audio portion in order to determine a speech portion; comparing the speech portion and the ambient noise portion in order to evaluate on a speech intelligibility of the initial audio signal and activating the first and/or second signal modifier for the step of modifying, if a value indicative for the speech intelligibility is below a threshold. Thus, it is advantageous that the processing takes place only at passages, where speech occurs. Here, a modified sound mix is generated for this speech portion, wherein the sound mix aims to fulfill or maximizes specific perceptual metrics.

An embodiment of the present invention provides a method, wherein the initial audio signal comprises a plurality of time frames or scenes, wherein the basic steps are repeated for each time frame or scene.

According to embodiments it is possible that a first timeframe is adapted using a first modifier, wherein for a second timeframe another modifier is selected. In order to ensure perceptual continuity, a transition between the timeframe or an adaptation portion of the two timeframes can be inserted. For example, the end of the first timeframe and the beginning of the subsequent timeframe are adapted with regard to its adapting performance. For example, a kind of interpolation between the two adaptation methods can be applied. According to further embodiments, it is possible that for all or a plurality of subsequent timeframes the same modifier is used in order to enable perceptual continuity. According to further embodiments, it is also possible that an adaptation of a timeframe is performed, even if there is no adaptation required, e.g. from the point of view of the intelligibility performance. However, this enables to ensure the perceptual similarity between the respective timeframes.

An embodiment of the present invention provides a computer program having a program code for performing, when running on a computer, according to the above method.

Another embodiment of the present invention provides an apparatus for processing an initial audio signal. The apparatus comprises an interface for receiving the initial audio signal; respective modifiers for processing the initial audio signal to obtain the respective modified audio signals, an evaluator for performing the evaluation of the respective modified audio signals and a selector for selecting the first or second modified audio signal dependent on the respective first or second evaluation value.

### BRIEF DESCRIPTION OF THE DRAWINGS

Embodiments of the present invention will be discussed below in detail, making reference to the enclosed figures. Here,

FIG. 1 schematically shows a method sequence for processing an audio signal so as to improve the reproduction quality of a target portion, like a speech portion of the audio signal according to a basic embodiment;

FIG. 2 shows a schematic flow chart illustrating enhanced embodiments; and

FIG. 3 shows a schematic block diagram of a decoder for processing an audio signal according to an embodiment.

### DETAILED DESCRIPTION OF THE INVENTION

Below, embodiments of the present invention will subsequently be discussed referring to the enclosed figures, wherein identical reference numerals are provided to objects having identical or similar functions.

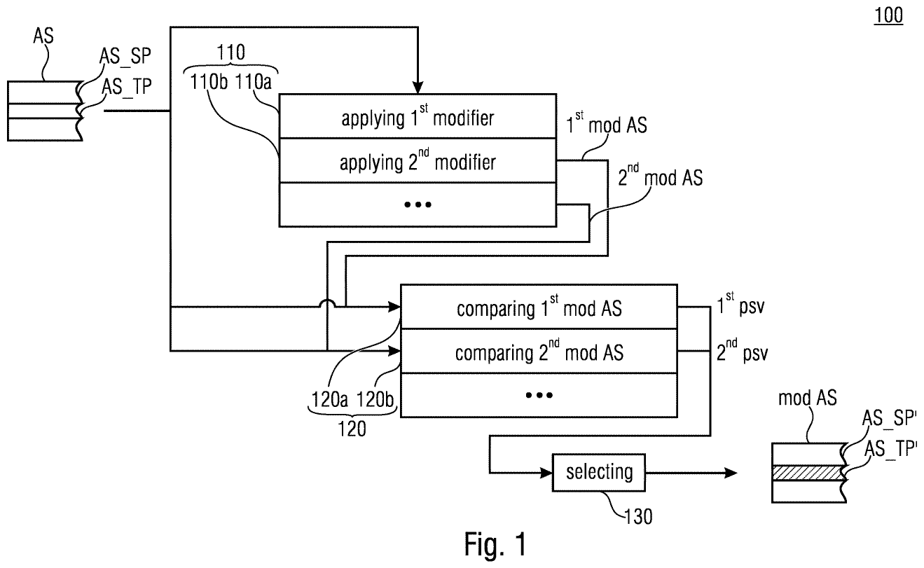

FIG. 1 shows a schematic flow chart illustrating a method 100 comprising three steps/step groups 110, 120 and 130. The method 100 has the purpose of enabling a processing of an initial audio signal AS and can have the result of outputting a modified audio signal MOD AS. The subjunctive is used, since a possible result of the output audio signal MOD AS can be that a processing of the audio signal AS is not necessary. Then, the audio signal and the modified audio signal is the same.

The three basic steps 110 and 120 are interpreted as step groups, since here sonar steps 110a, 110b, etc. and 120a are performed in parallel or sequentially to each other.

Within the group of steps 110, the audio signal AS is processed separately by use of different modifiers/processing approaches. Here, two exemplary steps of applying a first and a second modifier, which are marked by the reference numerals 110a, 110b, are shown. Both steps can be performed in parallel or sequentially to each other, and perform a processing of the audio signal AS. The audio signal may, for example, be an audio signal comprising one audio track, wherein this audio track comprises two signal portions. For example, the audio track may comprise a speech signal portion (target portion) and an ambient noise signal portion (side portion). These two portions are marked by the reference numeral AS_TP and AS_SP. In this embodiment, it is assumed that the AS_TP should be extracted from the audio signal AS or identified within the audio signal AS in order to amplify this signal portion AS_TP so as to increase the speech intelligibility. This process can be done for an audio signal having just one audio track comprising the two portions AS_SP and AS_TP without separation of an audio AS comprising a plurality of audio tracks, e.g., one for the AS_SP and one for the AS_TP.

As discussed above, there are a plurality of possible modifications of an audio signal AS all enabling to improve the speech intelligibility, e.g., by amplifying the AS_TP portion or by decreasing the AS_SP portion. Further examples are lowering non-speech channels, dynamic range control, dynamic equalization, spectral sharpening, frequency transposition, speech extraction, noise reduction or other speech enhancing action as discussed in context of the known technology. The efficiency of these modifications is dependent on a plurality of factors, e.g., dependent on the recording itself, the format of AS (e.g., the format having just one audio track or a format having a plurality of audio tracks) or dependent on a plurality of other factors. In order to enable an optimal speech intelligibility at least two signal modifications are applied to the signal AS. Within the first step 110a, the received initial audio signal AS is modified by use of a first modifier to obtain a first modified audio signal first MOD AS. Independently from the step 110a, a second modifying of the receiving initial audio signal AS is performed by use of a second modifier to obtain a second modified audio signal second MOD AS. For example, the first modifier may be based on a dynamic range control, wherein the second modifier may be based on a spectral shaping. Of course, other modifiers, e.g., based on dynamic equalization, frequency retransmission, speech extraction, noise reduction or the speech enhancing factions, or combinations of such modifiers, may also be used instead of the first and/or second modifier or as a third modifier (not shown). All approaches can lead to a different resulting modified audio signal first MOD AS and second MOD AS, which may differ with regard to the speech intelligibility and with regard to the similarity to the initial audio signal AS. These two parameters or at least one of these two parameters are evaluated within the next step 120.

In detail, within the step 120a, the first modified audio signal 1st MOD AS is compared to the original audio signal AS in order to find out the similarity. Analogously, within the step 120b, the second modified audio signal second MOD AS is compared to the initial audio signal AS. For the comparison, the entity performing the step 120 receives the audio signal AS directly and the first/second MOD AS. The result of this comparison is a first and second perceptual similarity value, respectively. Two values are marked by the reference numeral first PSV and second PSV. Both values describing a perceptual similarity between the respective first/second modified audio signal first MOD AS, second MOD AS and the initial audio signal AS. Under the assumption that the improvements for the speech intelligibility are sufficient, the first or second modified audio signal is selected having the first/second PSV indicating the higher similarity. This is performed by the step of selecting 130.

The result of the selection can, according to embodiments, be output/forwarded, so that the method 100 enables to output a respective modified audio signal first MOD AS or second MOD AS having the highest similarity with the original signal. As can be seen, the modified audio signal MOD AS still comprises the two portions AS_SP′ and AS_TP′. As illustrated by the within the AS_SP′ and AS_TP′ both or at least one of the two portions AS_SP′ and AS_TP′ is modified. For example, the amplification for AS_TP′ may be increased.

According to a further embodiment, it is possible that within the step 120 an enhanced evaluation is performed. Here, it is then further proved whether the modifications performed by the first or the second modifier (cf. step 110a and 110b) are sufficient and improve the speech intelligibility. For example, it may be analyzed, wherein the ratio between AS_TP′ to AS_SP′ is larger than the ratio between AS_TP and AS_SP.

The above embodiments start from the assumption that the aim of this method 100 is a MOD AS having an improved speech intelligibility. According to further embodiments, the aim of the modification may be different. For example, the portion AS_TP may be another portion, in general a target portion, which should be emphasized within the entire modified signal MOD AS. This can be done by emphasizing/amplifying AS_TP′ and/or by modifying AS_SP′.

Also, the above embodiment of FIG. 1 has been discussed in the context of perceptual similarity. It should be noted that this approach can be used more generally for other evaluation criteria. FIG. 1 starts from the assumption that the evaluation criterion is the perceptual similarity. However, according to further embodiments, also another evaluation criterion can be used instead of additionally. For example, the speech intelligibility can be used as an evaluation criterion. In such a case an evaluation of the first modified audio signal first MOD AS is made instead of step 120a, wherein in step 120b an evaluation of the second modified audio signal second MOD AS is performed. The result of these two steps of evaluating 120a and 120b is a respective first and second evaluation value. After that step 130 is performed based on the respective evaluation value.

Further evaluation criteria can be the loudness or the auditory spaciousness, etc.

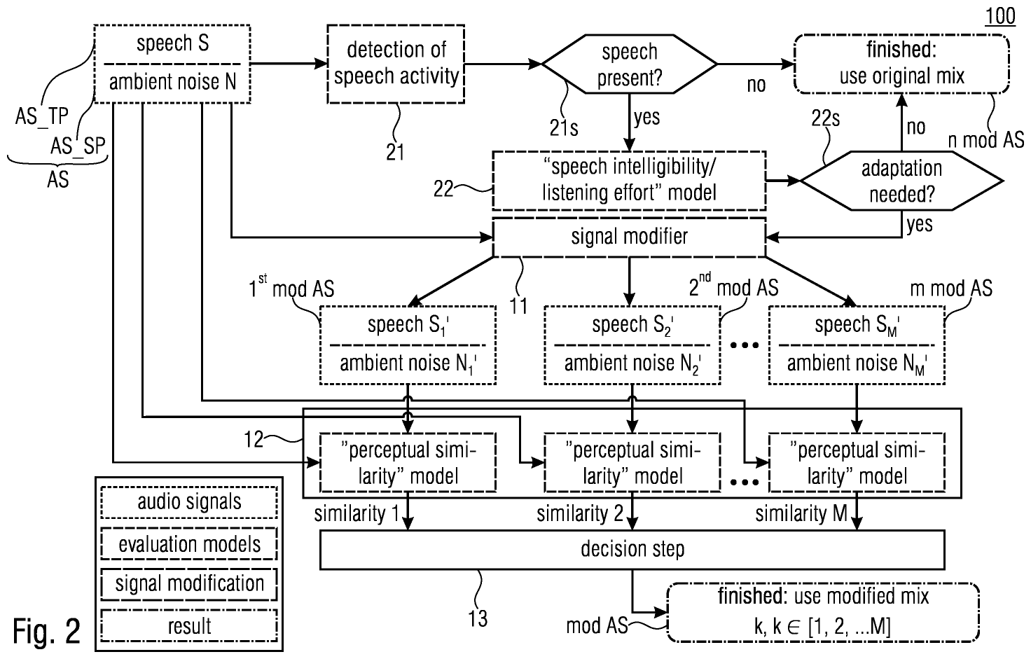

Taking reference to FIG. 2, further embodiments with enhanced features will be discussed below.

FIG. 2 shows a schematic flow chart enabling to process the audio signal AS comprising the two portions AS_TP (speech S) and AS_SP (ambient noise N). Here, a signal modifier 11 is used to process the signal AS so that the selecting entity 13 can output the modified signal mode AS. In this embodiment, the modifier performs different modifications 1, 2, . . . , M. These modifications are based on the plurality of different models so as to generate the three modified signal first MOD AS, second MOD AS and M MOD AS. For each signal first MOD AS, second MOD AS and M MOD AS, the two portions S1′, N1′, S2′, N2′ and SN′, NNM′ are illustrated. The output signal of first MOD AS, second MOD AS and M MOD AS are evaluated by the evaluator 12 regarding its perspective similarity to the initial signal AS. Thus, the one or more evaluator stages 12 receive the signal AS and the respective modified signal first MOD AS, second MOD AS, and M MOD AS. Output of this evaluation 12 is the respective modification signal first MOD AS, second MOD AS and M MOD AS together with a respective similarity information. Based on this similarity information, the position stage 13 decides on the modulated signal MOD AS to be output.

According to embodiments, the signal AS may be analyzed by an analyzer 21 so as to determine whether speech is present or not. This decision step is marked by 21s in case there is no speech or no signal to be modified within the initial audio signal AS. The initial/original audio signal AS is used as signal, i.e., without modification (cf. N-MOD AS).

In case, there is speech, a second analyzer 22 analyses whether there is the need for improving the speech intelligibility. This decision point is marked by the reference numeral 22s. In case there is no modification needed, the original signal AS is used as the signal to be output (cf. N-MOD AS). In case the modification is recommended, the signal modifier 11 is enabled.

Based on this structure, improvement of speech intelligibility in audio and audio visual media is possible. Here, the sound mix to be processed can either be a finished mix or can consist of separate audio tracks or sound objects (e.g., dialog, music, reverberation, effects). In a first step, the signals are analyzed with respect to the presence of speech (cf. reference numeral 21, 21s). The speech-active passages will be analyzed further (cf. reference numeral 22, 22s) with respect to physical or psychoacoustic parameters, e.g., in the form of calculated values of speech intelligibility (such as SII) or listening effort, for example based on the approach for mixed signals presented in [7]. Based on this evaluation, by comparing the parameters with targets or thresholds, a decision is made whether the speech intelligibility is sufficient or whether sound adaptation is needed. If no adaptation is needed, sound mixing takes place as usual or the original mix AS is maintained. If adaptation is needed, algorithms modifying the audio track or the different audio tracks such that the desired intelligibility is obtained will be applied. Up to here, this method is similar to the approaches disclosed in U.S. Pat. No. 8,195,454 B2 and U.S. Pat. No. 8,271,276 B1, but not limited to the details stated in the respective claim 1.

This means, according to embodiments, that a model-based selection 13 of sound reduction methods exceeding the maximization of loudness of non-speech channels, e.g., described in U.S. Pat. No. 8,577,676 B2 and US 2016/0071527 A1 is performed with this concept. For the selection, a further model stage 12 is applied, which simulates the perceptual similarity between the original mix AS and the mix amended in different ways (first MOD AS, second MOD AS, M MOD AS) based on physical and/or psychoacoustical parameters. Here, the original mix AS, as well as different types of the amended mix first MOD AS, second MOD AS, M MOD AS, serve as input into the further model stage 12.

For obtaining the target of maintaining the sound scene as best as possible, that method for sound adaptation can be selected (cf. reference numeral 13) that obtains the desired intelligibility with the signal modification that is least perceptually noticeable.

According to embodiments, possible models that can measure a perceptual similarity in an instrumental manner and could be used herein are, for example, PEAQ [8], POLQA [9] or Pemo-Q [10]. Also or additionally, further physical (e.g., level) or psychoacoustic metrics (e.g., loudness, pitch, perceived source width) can be used for evaluating the perceptual similarity.

The audio stream typically comprises different scenes arranged along the time domain. Therefore it is—according to embodiments—possible that different sound adaptations take place at different times in the audio track AS in order to have a minimum intrusive perceptual effect. If, for example, speech AS_TP and background noise AS_TP already have clearly different spectra, simple SNR adaptation can be the best solution since the same maintains the authenticity of the background noise to the best possible effect. If further speakers superpose the target speech, other methods (e.g., dynamic compression) might be better for fulfilling the optimization targets.

According to further embodiments, this model-based selection can consider possible hearing impairment of the future listener of the audio material in the calculations, e.g., in the form of an audiogram, an individual loudness function or in the form of inputting individual sound preferences. Thereby, speech intelligibility is not only ensured for people with normal hearing abilities but also for people with a specific form of hearing impairment (e.g., age-related hearing loss) and also considers that the perceptual similarity between original and processed version may vary individually.

Note, the analysis of speech intelligibility and the perceptual similarity by the models as well as the respective signal processing can take place for the entire sound mix or only for parts of the mix (individual scenes, individual dialogs) or can take place in short time windows along the entire mix such that a decision whether sound adaptation has to take place can be made for each window.

Below, examples of such processes will be exemplarily discussed:
i. No sound adaptation: If the analysis of the listening models shows that sufficiently high speech intelligibility is ensured, no further sound adaptation will take place. Alternatively, the below adaption is performed in order to avoid perceptual differences between the different scenes. Also an “interpolation” between no processing and the below selected processing may be performed. Both modes enable perceptual continuity over the different time frames/scenes.
   For separate audio tracks for dialog and background noise, the following steps are possible:
ii. Adapting the sound signal: Only the audio track of the speech signal is processed for improving the speech intelligibility, e.g., by raising the level, by frequency weighting and/or single or multi-channel dynamic compression.
iii. Adapting the interfering noise: One or several of the audio tracks not including speech are processed for improving speech intelligibility, e.g., by lowering the level, by frequency weighting and/or single or multi-channel dynamic compression. The trivial case of completely eliminating the background noise would result in improved speech intelligibility is, however, not practicable for reasons of sound aesthetics since the design of music, effects, etc., is also an essential part of creative sound design.
iv. Adapting all audio tracks: Both the audio track of the speech signal and one or several of the other audio tracks are processed by the above stated methods for improving speech intelligibility.

Note, for the adaption artificial intelligence, e.g. using neuronal networks, can be used. In already mixed audio signals (i.e., non-separate audio tracks for dialog and background noise), steps ii-iv can, for example, also be performed when a source separation method is used beforehand, which separates the mix into speech and one or several background noises. Then, improving speech intelligibility could consist, for example, in remixing the separate signal at an improved SNR or in modifying the speech signal and/or the background noise or part of the background noise by frequency weighting or single or multi-channel dynamic compression. Here, again the sound adaption that improves both the speech intelligibility as desired and at the same time maintains the original sound as best as possible would be selected. It is possible that methods for source separation are applied without any explicit stage for detecting speech activity.

Note according to embodiments, the selection of the respective processing may be performed by use of artificial intelligence/neuronal networks. This artificial intelligence/neuronal network can, for example, be used if there are more than one factor for the selection, e.g. perceptual value and loudness value or a value describing the matching to the personal listening preference.

Above it has been discussed that it is possible to perform an adaption of scenes, even if it is not necessary, to maintain perceptual continuity over the different time frames/scenes. According to another variant it is possible, to select an adaption for a plurality or all scenes. Further, it should be noted that between the different scenes a kind of transition between the differently adapted or adapted and non-adapted scenes can be integrated to maintain the perceptual continuity.

According to embodiments, evaluation and optimization based on the perceptual similarity (cf. reference numeral 12) can relate to target language, background noise or the mix of speech and background noise. There could be, for example, different thresholds for the perceptual similarity of the processed speech signal, the processed background noise or the processed mix to the respective original signals, so that a specific degree of signal modification for the respective signals may not be exceeded. A further boundary condition could be that background noise (such as music) may not perceptually change too much with respect to preceding or succeeding points in time, since otherwise the continuity of perception would be disturbed when, for example, in the moments with speech presence, the music would be lowered too much or would be changed in its frequency content, or the speech of an actor may not change too much during the course of a film. Such boundary conditions could also be examined based on the above stated models.

This might have the effect that the desired improvement of intelligibility may not be obtained without interfering too much with the perceptual similarity of speech and/or background noise. Here a (possibly configurable) deciding stage could decide which target is to be obtained or whether and how a tradeoff is to be found.

Here, processing can take place iteratively, i.e., examining the listening models can take place again after sound adaptation in order to validate that the desired speech intelligibility and perceptual similarity with respect to the original has been obtained.

Processing can take place (depending on the calculation of the listening models) for the entire duration of the audio material or only for parts (e.g., scenes, dialogs) of the same.

Embodiments can be used for all audio and audiovisual media (films, radio, podcasts, audio rendering in general). Possible commercial applications are, for example:
i. Internet-based service where the customer loads his audio material, activates automated speech intelligibility improvement and downloads the processed signals. The same can be extended by customer specific selection of the sound adaptation methods and the degree of sound adaptation. Such services already exist, but no listening models for sound adaptations regarding speech intelligibility are used (see above under 2.(V.)).
ii. Software solution for tools for sound production, e.g., integrated in digital audio workstations (DAWs) to enable correction of filed or currently produced sound mixes.
iii. Test algorithm identifying passages in the audio material that do not correspond to the desired speech intelligibility and possibly offering the user the suggested sound adaptation modifications for selection.
iv. Software and/or hardware integrated in end devices at the listener's end of the broadcasting chain, such as for example soundbars, headphones, television devices or devices receiving streamed audio content.

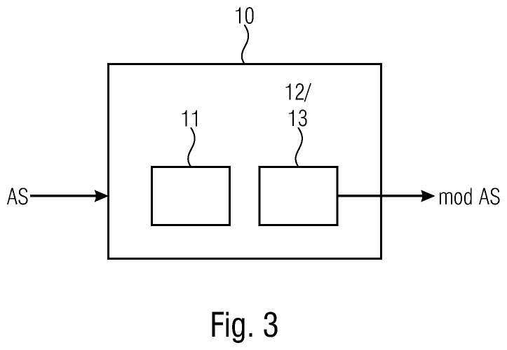

The method discussed in context of FIG. 1 or the concept discussed in context of FIG. 2 can be implemented by use of a processor. This processor is illustrated by FIG. 3.

FIG. 3 shows a processor 10 in the two stages signal modifier 11 and evaluator/selector 12 and 13. The modifier receives from an interface the audio signal and performs based on different models the modification in order to obtain the modified audio signal MOD AS. The evaluator/selector 12, receives from an interface the audio signal and performs based on different models the modification in order to obtain the modified audio signal MOD AS. The evaluator/selector 12, 13 evaluates the similarity and selects based on this information the signal having the highest similarity or a high similarity and improved speech intelligibility which is sufficient so as to output the MOD AS.

Of course, these two stages 11, 12 and 13 can be implemented by one processor.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a microprocessor, a programmable computer or an electronic circuit. In some embodiments, some one or more of the most important method steps may be executed by such an apparatus.

The inventive encoded audio signal can be stored on a digital storage medium or can be transmitted on a transmission medium such as a wireless transmission medium or a wired transmission medium such as the Internet.

Depending on certain implementation requirements, embodiments of the invention can be implemented in hardware or in software. The implementation can be performed using a digital storage medium, for example a floppy disk, a DVD, a Blu-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. The data carrier, the digital storage medium or the recorded medium are typically tangible and/or non-transitionary.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods may be performed by any hardware apparatus.

While this invention has been described in terms of several embodiments, there are alterations, permutations, and equivalents which will be apparent to others skilled in the art and which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

### REFERENCES

[1] Simon, C. and Fassio, G. (2012). Optimierung audiovisueller Medien für Hörgeschädigte. In: Fortschritte der Akustik—DAGA 2012, Darmstadt, March 2012.
[2] Ephraim, Y. und Malah, D. (1984). Speech enhancement using a minimum-mean square error short-time spectral amplitude estimator. IEEE Transactions on Acoustics Speech and Signal Processing, 32(6):1109-1121.
[3] Kolbæk, M., Yu, D., Tan, Z-H., & Jensen, J. (2017). Multitalker Speech Separation With Utterance-Level Permutation Invariant Training of Deep Recurrent Neural Networks. IEEE Transactions on Audio, Speech and Language Processing, 25(10), 1901-1913. https://doi.org/10.1109/TASLP.2017.2726762
[4] Jouni, P., Torcoli, M., Uhle, C., Herre, J., Disch, S., Fuchs, H. (2019). Source Separation for Enabling Dialogue Enhancement in Object-based Broadcast with MPEG-H. JAES 67, 510-521. https://doi.org/10.17743/jaes.2019.0032
[5] Sauert, B. and Vary, P. (2012). Near end listening enhancement in the presence of bandpass noises. In: Proc. der ITG-Fachtagung Sprachkommunikation, Braunschweig, September 2012.
[6] ANSI S3.5 (1997). Methods for calculation of speech intelligibility index.
[7] Huber, R., Pusch, A., Moritz, N., Rennies, J., Schepker, H., Meyer, B. T. (2018). Objective Assessment of a Speech Enhancement Scheme with an Automatic Speech Recognition-Based System. ITG-Fachbericht 282: Speech Communication, 10.-12. October 2018 in Oldenburg, 86-90.
[8] ITU-R Recommendation BS.1387: Method for objective measurements of perceived audio quality (PEAQ)
[9] ITU-T Recommendation P.863: Perceptual objective listening quality assessment
[10] Huber, R. und Kollmeier, B. (2006). PEMO-Q—A New Method for Objective Audio Quality Assessment Using a Model of Auditory Perception. IEEE Transactions on Audio, Speech, and Language Processing 14(6), 1902-1911
[11] NetMix player of Fraunhofer IIS, http://www.iis.fraunhofer.de/de/bf/amm/forschundentw/forschaudiomulti/dialogenhanc.html
[12] https://auphonic.com/.

1. A method for processing an initial audio signal comprising a target portion and a side portion, comprising:
a. receiving of the initial audio signal;
b. modifying the received initial audio signal by use of a first signal modifier to acquire a first modified audio signal;
modifying the received initial audio signal by use of a second signal modifier to acquire a second modified audio signal;
c. evaluating the first modified audio signal with respect to an evaluation criterion to acquire a first evaluation values describing a degree of fulfilment of the evaluation criterions;
evaluating the second modified audio signal with respect to the evaluation criterion to acquire a second evaluation values describing a degree of fulfilment of the evaluation criterions; and
d. selecting the first or second modified audio signal dependent on the respective first or second evaluation value; wherein selecting is performed based on a plurality of independent first evaluation values and independent second evaluation values or based on at least two independent evaluation criterions.

2. The method according to claim 1, wherein the evaluation criterions are out of the group comprising:
perceptual similarity, described by a first and second perceptual similarity value, the first and the second perceptual similarity value describing a perceptual similarity between the respective first and second modified audio signal and the initial audio signal AS;
speech intelligibility, in the form of calculated values of speech intelligibility to be compared with targets or thresholds;
loudness, described by a loudness value;
sound pattern;
spatiality.

3. The method according to claim 1, wherein the at least two independent evaluation criterions are evaluated separately, such that respective first evaluation values describing a degree of fulfilment of for at least two independent evaluation criterions for the first modified audio signal and respective second evaluation values describing a degree of fulfilment of for the at least two independent evaluation criterions for the second modified audio signal are determined, wherein then the selection is performed based on weighted first and second evaluation values.

4. The method to according to claim 1, wherein the evaluation criterions is the perceptual similarity, and wherein step c comprises the substeps of
comparing received initial audio signal with the first modified audio signal to acquire a first perceptual similarity value as first evaluation value describing the perceptual similarity between the initial audio signal and the first modified audio signal; and
comparing the received initial audio signal with the second modified audio signal to acquire a second perceptual similarity value as second evaluation value describing the perceptual similarity between the initial audio signal and the second modified audio signal.

5. The method according to claim 4, wherein the first modified audio signal is selected, wherein the first perceptual similarity value is higher than the second perceptual similarity value so as to indicate a higher perceptual similarity of the first modified audio signal; and
wherein the second modified audio signal is selected when the second perceptual similarity value is higher than the first perceptual similarity value so as to indicate a higher perceptual similarity of the second modified audio signal.

6. The method to according to claim 1, further comprising outputting the first or second modified audio signal dependent on the selection of step d.

7. The method according to claim 3, wherein outputting the initial audio signal is performed instead of outputting the first or second modified audio signal, when the respective first or second perceptual similarity value is below a threshold, below which threshold a respective first or second modified audio signal is indicated as not sufficiently similar to the initial audio signal.

8. The method according to claim 1, wherein the target portion is a speech portion of the initial audio signal and the side portion is an ambient noise portion of the audio signal.

9. The method according to claim 1, wherein the first and/or second modified audio signal comprises the target portion moved into the foreground and the side portion moved into the background and/or a speech portion as the target portion moved into the foreground and an ambient noise portion as the side portion moved into the background.

10. The method according to claim 1, wherein comparing comprises extracting the first and/or second evaluation value by use of a perceptual model, PEAQ model, POLQA model, and/or a PEMO-Q model.

11. The method according to claim 1, wherein the first and/or second evaluation value is dependent on a physical parameter of the first or second modified audio signal, a volume level of the first or second modified audio signal, a psychoacoustic acoustic parameter for the first or second modified audio signal, a loudness information of the first or second modified audio signal, a pitch information of the first or second modified audio signal, and/or a perceived source width information of the first or second modified audio signal.

12. The method according to claim 1, wherein the first and/or second signal modifier is configured to perform an SNR increase, a dynamic compression, an SNR increase for the initial audio signal, and/or a dynamic compression of the initial audio signal; and/or
wherein modifying comprises increasing the target portion, increasing a frequency weighting for the target portion, dynamically compressing the target portion, decreasing the side portion, decreasing a frequency weighting for the side portion, if the initial audio signal comprises a separate target portion and a separate side portion; and/or
wherein modifying comprises performing a separation of the target portion and the side portion, if the initial audio signal comprises a combined target portion and side portion.

13. The method according to claim 1, wherein selecting is performed taking into consideration one or more of the below factors:
grade of hardness of hearing for hearing-impaired persons;
individual hearing performance;
individual frequency-dependent hearing performance;
individual preference;
individual preference regarding signal modification rate.

14. The method according to claim 1, wherein modifying and/or comparing is performed taking into consideration one or more of the below factors:
grade of hardness of hearing for hearing-impaired persons;
individual hearing performance;
individual frequency-dependent hearing performance;
individual preference;
individual preference regarding signal modification rate.

15. The method according to claim 1, wherein the method further comprises receiving an information on an optimization target defining individual preference; wherein the evaluation criterion is dependent on the optimization target; or wherein modifying and/or evaluating and/or selecting is dependent on the optimization target; or wherein a weighting of independent first and second evaluation values describing independent evaluation criterions for selecting is dependent on the optimization target.

16. The method according to claim 4, wherein comparing is performed for the entire initial audio signal and the entire first and second modified audio signal; and/or
for the target portion of the individual audio signal and a respective target portion of the first and second modified audio signal; and/or
for the side portion of the initial audio signal and the side portion on the first and second modified audio portion.

17. The method according to claim 1, wherein the initial audio signal comprises a plurality of time frames and wherein steps a-d are repeated for each time frame; and/or
wherein the steps a-d are repeated for a time portion or time frame of a scene of the initial audio signal.

18. The method according to claim 1, wherein an adaption of the initial audio signal comprising a plurality of time frames is performed for the time frames for which the adaption is applied and for the other time frames in order to maintain a perceptual continuity or wherein an adaption of the initial audio signal comprising a plurality of time frames is performed for the time frames for which the adaption is applied and in an interpolated manner for the other time frames in order to maintain a perceptual continuity; and/or
wherein the adaption of a first and a second subsequent time frame is performed such that a transition between the first and the second subsequent time frame is formed in order to maintain a perceptual continuity.

19. The method according to claim 1, wherein the method further comprises the initial steps of:
analyzing the initial audio portion in order to determine a speech portion;
comparing the speech portion and the ambient noise portion in order to evaluate on a speech intelligibility of the initial audio signal; and
activating the first and/or second signal modifier for modifying, if a value indicative for the speech intelligibility is below a threshold.

20. A non-transitory digital storage medium having stored thereon a computer program for performing a method for processing an initial audio signal comprising a target portion and a side portion, comprising:
a. receiving of the initial audio signal;
b. modifying the received initial audio signal by use of a first signal modifier to acquire a first modified audio signal;
modifying the received initial audio signal by use of a second signal modifier to acquire a second modified audio signal;
c. evaluating the first modified audio signal with respect to an evaluation criterion to acquire a first evaluation values describing a degree of fulfilment of the evaluation criterions;
evaluating the second modified audio signal with respect to the evaluation criterion to acquire a second evaluation values describing a degree of fulfilment of the evaluation criterions; and
d. electing the first or second modified audio signal dependent on the respective first or second evaluation value; wherein selecting is performed based on a plurality of independent first evaluation values and independent second evaluation values or based on at least two independent evaluation criterions, when said computer program is run by a computer.

21. An apparatus for processing an initial audio signal comprising a target portion and a side portion, the apparatus comprising:
an interface for receiving the initial audio signal;
a first signal modifier for modifying the received initial audio signal to acquire a first modified audio signal and a second signal modifier for modifying the received initial audio signal to acquire a second modifier audio signal;
an evaluator for evaluating the first modified audio signal with respect to an evaluation criterion to acquire a first evaluation value describing a degree of fulfilment of the evaluation criterion and evaluating the second modified audio signal with respect to the evaluation criterion to acquire a second evaluation value describing a degree of fulfilment of the evaluation criterion; and
a selector for selecting the first or second modified audio signal dependent on the respective first or second perceptual evaluation similarity value; wherein selecting is performed based on a plurality of independent first and second evaluation values or based on at least two independent evaluation criterions.
